(19) United States
(12) Patent Application Publication
(10) Pub. No.: US 2011/0041475 A1
(43) Pub. Date: Feb. 24, 2011

(54) ELASTOMER STRUCTURES, ROCKET MOTORS INCLUDING ELASTOMER STRUCTURES AND METHODS OF FORMING STRUCTURES FROM LAYERED VISCOELASTIC MATERIALS

(75) Inventors: Steven V. Hicken, Brigham City, UT (US); Justin Pancoast, Ogden, UT (US); Todd Noble, Smithfield, UT (US)

Correspondence Address: TRASKBRITT, P.C./ ALLIANT TECH SYSTEMS, P.O. BOX 2550, SALT LAKE CITY, UT, 84110, US

(73) Assignee: ALLIANT TECHSYSTEMS INC., Minneapolis, MN (US)

(21) Appl. No.: 12/544,907

(22) Filed: Aug. 20, 2009

(51) Int. Cl. F02K 9/08; B05D 1/36; B32B 3/26

(52) U.S. Cl. 60/253; 427/331; 428/221; 428/304.4

(57) ABSTRACT

Methods of forming structures from layered viscoelastic materials are disclosed. In some embodiments, such methods may include covering at least a portion of a first viscoelastic material layer disposed on a substrate with a portion of at least a second viscoelastic material layer and containing a quantity of gas within a space defined between a portion of the substrate, a portion of the first viscoelastic material layer and a portion of the second viscoelastic material layer. The methods may further include forming at least one discrete fluid path between the defined space containing the quantity of gas and the vacuum, and removing at least a portion of the quantity of gas from the defined space through the at least one discrete fluid path. Additionally, elastomer structures comprising at least one void defined therein, the at least one void exhibiting at least a partial vacuum, are disclosed.

### GOVERNMENT RIGHTS STATEMENT

The United States Government has certain rights in this invention pursuant to Contract Nos. NAS8-97238 and NNM07AA75C between the National Aeronautics and Space Administration and Alliant Techsystems Inc.

### TECHNICAL FIELD

The invention relates to removing gas from layered viscoelastic materials. In particular, embodiments of the invention relate to methods of forming structures from layered viscoelastic materials wherein gas may be removed from defined spaces through one or more discrete fluid paths. Additional embodiments relate to elastomer structures having at least one void defined therein exhibiting at least a partial vacuum.

### BACKGROUND

As is shown in FIG. 1, a solid rocket motor 10 may include an insulation material layer 12 bonded to an inner wall 14 of the casing 16. The insulation material layer 12 may be configured to separate the casing 16 from a propellant grain 18 (i.e., solid rocket fuel) and insulate the casing 16 from heat generated by the propellant grain 18 during a burn thereof in operation of solid rocket motor 10.

The insulation material layer 12 may be comprised of an elastomer material, such as a vulcanized nitrile butadiene rubber (NBR) (i.e., acrylonitrile butadiene), which may be reinforced by a fire resistant fiber.

The insulation material layer 12 may have a varying thickness within the casing 16 to provide a varying amount of thermal insulation for different regions of the rocket motor 10. For example, the insulation material layer 12 that is nearer to the nose portion may be thinner than the insulation layer near the nozzle portion, as the nozzle region may experience more heat during a burn than the nose region. Additionally, the casing 16 of the solid rocket motor 10 may be relatively large, for example the casing 16 may have a diameter of about 12 ft.

In view of the foregoing structural issues, it may be practical to prepare the insulation material layer 12 by applying a number of viscoelastic less than fully cured insulation material sheets, such as partially cured or uncured insulation material sheets, in a layered arrangement on the interior surface of the casing followed by a curing process (i.e., vulcanization). For example, where thicker insulation is desired, more layers of less than fully cured insulation material sheets may be applied, and less layers may be applied were thinner insulation is desired. Additionally, multiple contiguous less than fully cured insulation material sheets, having overlapping edges, may be arranged to cover a relatively large area with less than fully cured insulation material sheets having a manageable size.

Relatively high stress regions exist within the insulation material layer 12 due to supporting the weight of the propellant grain 18. In view of this, any trapped gas pockets within the insulation material layer 12 within or near a critical stress region may initiate fracture propagation and failure of the insulation material layer 12, which, in turn, may result in a catastrophic failure of the rocket motor 10. Additionally, an insulation material layer 12 including trapped gas pockets relatively near to the propellant grain 18 may off-gas (i.e., release gas) into the uncured propellant during casting operations, which may create voids at the interface between the insulation material layer 12 and the propellant grain 18 and within the propellant grain 18. Such voids between the insulation material layer 12 and the propellant grain 18 or within the propellant grain 18 may fracture during storage, vertical stack, or operation, which, in turn, may result in catastrophic failure of the rocket motor 10.

In view of the foregoing, improved vulcanized material structures and improved methods for removing gas from layered viscoelastic material layers would be desirable.

### BRIEF SUMMARY

In some embodiments, a method of forming a structure from layered viscoelastic material may include covering at least a portion of a first viscoelastic material layer disposed on a substrate with at least a portion of a second viscoelastic material layer, and containing a quantity of gas within a space defined between a portion of the substrate, a portion of the first viscoelastic material layer and a portion of the second viscoelastic material layer. The method may further include forming at least one discrete fluid path between the defined space containing the quantity of gas and a vacuum, and removing at least a portion of the quantity of gas from the defined space through the at least one discrete fluid path responsive to the vacuum.

In additional embodiments, a unitary elastomer structure comprises at least one void defined therein, the at least one void exhibiting at least a partial vacuum.

In yet additional embodiments, a solid rocket motor may comprise an insulation layer comprised of a unitary elastomer structure having at least one void defined therein, the at least one void exhibiting at least a partial vacuum.

### BRIEF DESCRIPTION OF THE DRAWINGS

FIG. 1 shows a cross-sectional view of a section of a solid rocket motor having an elastomer insulation layer positioned between a casing and a propellant grain.

FIG. 2 shows a cross-sectional view of an assembly including a substrate having less than fully cured viscoelastic material layers arranged thereon, the less than fully cured viscoelastic material layers containing a quantity of gas within a defined space, according to an embodiment of the present invention.

FIG. 3 shows a cross-sectional view of the assembly of FIG. 2 wherein a flexible membrane is positioned thereover and the assembly is placed within an autoclave, according to an embodiment of the present invention.

FIG. 4 shows a cross-sectional view of the assembly shown in FIG. 3, wherein a vacuum is formed under the flexible membrane, according to an embodiment of the present invention.

FIG. 5 shows a cross-sectional view of the assembly shown in FIG. 4, wherein a vacuum is also formed over the flexible membrane and the defined space begins to expand, according to an embodiment of the present invention.

FIG. 6 shows a cross-sectional view of the assembly shown in FIG. 5, wherein the defined space further expands to define a discrete fluid path between the defined space and the vacuum under the flexible membrane, according to an embodiment of the present invention.

FIG. 7 shows a cross-sectional view of the assembly shown in FIG. 6, wherein gas is injected over the flexible membrane and an isostatic pressure is applied thereover and voids under the less than fully cured viscoelastic material layers are eliminated, according to an embodiment of the present invention.

FIG. 8 shows a cross-sectional view of the assembly shown in FIG. 7, wherein heat is applied by the autoclave and the viscoelastic material layers are fully cured to form a unitary structure, according to an embodiment of the present invention.

FIG. 9 shows a cross-sectional view of the assembly shown in FIG. 8, wherein the unitary structure is removed from the autoclave and the flexible membrane is removed, according to an embodiment of the present invention.

FIG. 10 shows a cross-sectional view of the assembly shown in FIG. 6, wherein gas is injected over the flexible membrane and an isostatic pressure is applied thereover and a void exhibiting at least a partial vacuum therein is formed under the less than fully cured viscoelastic material layers, according to an embodiment of the present invention.

FIG. 11 shows a cross-sectional view of the assembly shown in FIG. 10, wherein the less than fully cured viscoelastic material layers are fully cured to form an elastomer structure having and a void exhibiting at least a partial vacuum therein, according to an embodiment of the present invention.

FIG. 12 shows a cross-sectional view of an assembly including a substrate having less than fully cured viscoelastic material layers arranged thereon, the less than fully cured viscoelastic material layers containing a quantity of gas within a defined space, and the assembly further including a gas permeable material providing a discrete fluid path, according to an embodiment of the present invention.

FIG. 13 shows a cross-sectional view of an assembly including a substrate having less than fully cured viscoelastic material layers arranged thereon, the less than fully cured viscoelastic material layers containing a quantity of gas within a defined space, and the assembly further including a groove formed in a surface of a less than fully cured viscoelastic material layer forming a discrete fluid path, according to an embodiment of the present invention.

FIG. 14 shows a transverse cross-sectional detail view of the assembly of FIG. 13.

FIG. 15 shows a cross-sectional view of an assembly including a substrate having a plurality of less than fully cured viscoelastic material layers arranged thereon, the less than fully cured viscoelastic material layers containing quantities of gas within a plurality of defined spaces, according to an embodiment of the present invention.

FIG. 16 shows a cross-sectional view wherein the quantities of gas contained within the plurality of less than fully cured viscoelastic material layers shown in FIG. 15 have been substantially removed and the plurality of less than fully cured viscoelastic material layers have been fully cured to form an elastomer structure having a plurality of voids exhibiting at least a partial vacuum therein, according to an embodiment of the present invention.

FIG. 17 shows an isometric cutaway view of a test apparatus that was used with a test specimen, according to an embodiment of the present invention.

FIG. 18 shows a cross-sectional view of a test specimen prepared for use with the test apparatus of FIG. 17, according to an embodiment of the present invention.

FIG. 19 shows graphed data correlating pressures, observed by transducers of the test apparatus of FIG. 17, to elapsed time.

### DETAILED DESCRIPTION

The illustrations presented herein are not meant to be actual views of any particular device or system, but are merely idealized representations that are employed to describe various embodiments of the present invention. It is noted that elements that are common between figures may retain the same numerical designation.

The reduction or elimination of trapped gas pockets within an elastomer structure may be measured in several ways. For example, the number and sizes of cavities within an elastomer structure may be measured to evaluate the amount of trapped gas in the elastomer structure. However, the number and size of cavities within the structure alone may not provide an accurate measure of problematic trapped gas pockets. It is important to also consider the pressure of the gases that may be trapped within a cavity, as this measurement may be more significant than the volume of the cavity. The amount of gas trapped within a cavity may not be accurately measured by volume alone, but may be measured with the combined measurements of the volume and the pressure. Additionally, a cavity having gas stored at a relatively high pressure may be more likely to cause a fracture or off-gas, when compared to a cavity having a relatively low pressure, even if the cavity exhibiting a lower pressure is larger in volume.

Unitary elastomer structures, and methods of forming such structures from layered viscoelastic material layers, are described herein; wherein pockets of trapped gas may be eliminated or reduced, not only in number and volume, but, more importantly, in molar quantity of gas and gas pressure.

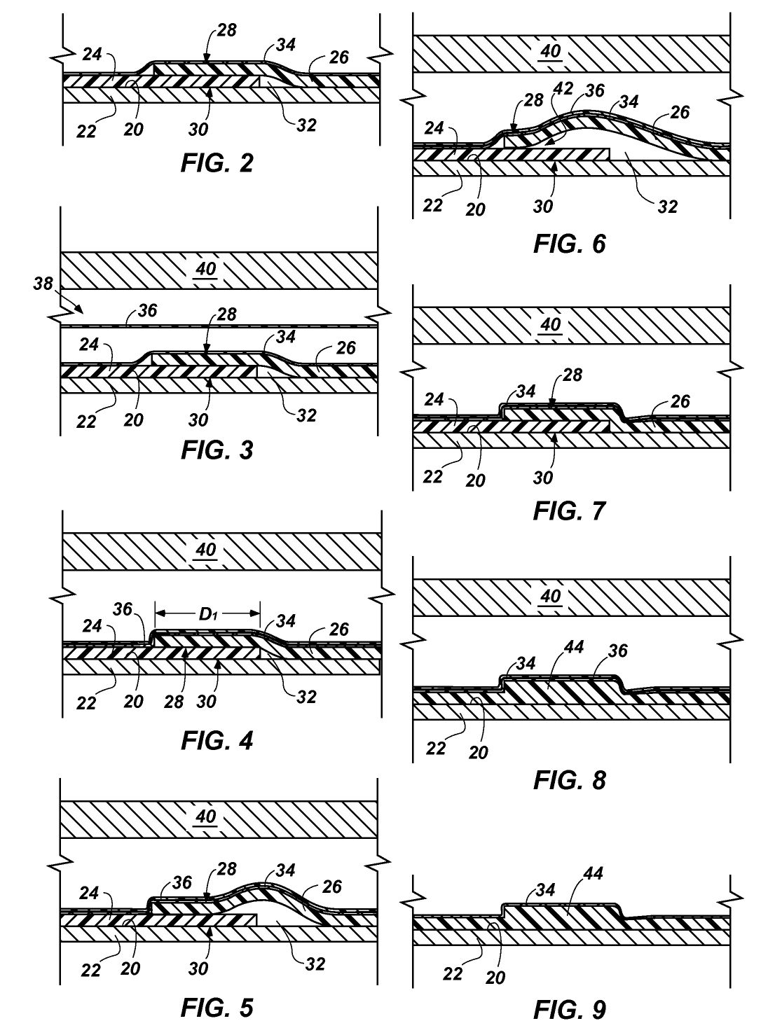

In some embodiments, such as shown in FIG. 2, a plurality of viscoelastic material layers 24, 26 may be arranged in layers on a surface 20 of a substrate 22. For example, a plurality of viscoelastic material layers 24, 26 may be arranged with a first viscoelastic material layer 24 placed on the surface 20 of the substrate 22, and then a second viscoelastic material layer 26 placed on the surface 20 and having an edge portion 28 overlapping an edge portion 30 of the first viscoelastic material layer 24. Although the edges of the viscoelastic material layers 24, 26 are shown having edges cut at a perpendicular angle (i.e., squared-off), it may be understood by one of ordinary skill in the art that the edges may also be cut at an angle, such as 45 degrees or less (i.e., skived).

In some embodiments, the substrate 22 may comprise a substantially rigid structure, such as a steel structure, having a surface 20 (i.e., an interior surface of a solid rocket motor casing), which may optionally have a surface treatment applied thereto, and the viscoelastic material layers 24, 26 may be positioned directly thereon. In additional embodiments, the substrate 22 may comprise another viscoelastic material layer, such as a third viscoelastic material layer, and the viscoelastic material layers 24, 26 may be positioned on the third viscoelastic material layer. In yet further embodiments, the substrate 22 may comprise a plurality of layers, such as a substantially rigid layer having one or more viscoelastic material layers positioned thereon.

In some embodiments, the viscoelastic material layers 24, 26 may be comprised of a less than fully cured rubber material, such as a nitrile butadiene rubber (NBR) (i.e., acrylonitrile butadiene), which may be reinforced by a fire resistant fiber. For example, the viscoelastic material layers 24, 26 may be comprised of one of asbestos fiber reinforced nitrile butadiene rubber (ASNBR) and polybenzimidazole fiber reinforced nitrile butadiene rubber (PBI-NBR), which may be uncured or partially cured.

The first and second viscoelastic material layers 24, 26 may have outer surfaces that are sticky (i.e., adhesive). For example, the first and second viscoelastic material layers may be comprised of partially cured rubber and the material at the surfaces of the first and second viscoelastic material layers may adhere with other surfaces that they come into contact with, especially the surfaces of another viscoelastic material layer. In view of this, the viscoelastic material layers 24, 26 may have sufficient adhesion to the substrate 22 and underlying viscoelastic material layers 24 to allow the viscoelastic material layers 24, 26 to be applied to a surface 20 of a substrate 22 positioned above the viscoelastic material layers 24, 26 and resist gravitational forces acting to pull the viscoelastic material layers 24, 26 away from the substrate 22.

A defined space 32 may be formed, such as under the second viscoelastic material layer 26 adjacent to the edge portion 30 of the first viscoelastic material layer 24, and a quantity of gas (i.e., air) may be contained within the defined space 32. For example, although the viscoelastic material layers 24, 26 may be fiber reinforced, the viscoelastic material layers 24, 26 may not be gas permeable and gases may be unable to pass through the viscoelastic material layers 24, 26. In view of this, a quantity of gas may be contained within the defined space 32, such as ambient air that may be present at the location of assembly. The viscoelastic material layers 24, 26 may then be covered by a material layer, such as a woven polyester fabric 34 that may be used to apply a texture to surfaces of the viscoelastic material layers 24, 26 during subsequent curing.

As shown in FIG. 3, the woven fabric 34 may then be covered by a flexible membrane 36, such as a polymeric bag. A vacuum pump (not shown) may be coupled to the flexible membrane 36, and the assembly 38 may be placed in a vacuum chamber, such as an autoclave 40 having a vacuum pump (not shown) attached thereto.

At this point, the air pressure within the defined space 32, the air pressure between the viscoelastic material layers 24, 26 and the flexible membrane 36 and the air pressure between the flexible membrane 36 and the autoclave 40 may each be at substantially the same ambient condition (i.e., local atmospheric pressure) and may apply equal pressure forces on each side of the flexible membrane 36 and the viscoelastic material layers 24, 26.

Next, as shown in FIG. 4, air may be removed from between the flexible membrane 36 and the viscoelastic material layers 24, 26 and a vacuum may be formed between the flexible membrane 36 and the viscoelastic material layers 24, 26. As the pressure is reduced beneath the flexible membrane 36, the ambient air pressure over the flexible membrane 36 may press the flexible membrane 36 into the underlying viscoelastic material layers 24, 26. For example, the vacuum formed beneath the flexible membrane 36 may cause a difference in pressure of about 12.6 psi between the ambient space over the flexible membrane 36 and the vacuum beneath the flexible membrane 36 at an altitude above sea level of about 4,200 ft.

As used herein, the term “vacuum” means a space that has a gas pressure that is significantly less than atmospheric air pressure; as a non-limiting example, a space having a gas pressure less than about 1 psia is a vacuum.

As indicated in FIG. 4, a distance D₁ between the defined space and the vacuum may be defined by the overlapping edge portions 28, 30 of the first and second viscoelastic material layers 24, 26, which may be compressed together by the isostatic air pressure over the flexible membrane 36. As the first and second viscoelastic material layers 24, 26 are pressed together, the adhesive bond between the first and second viscoelastic material layers 24, 26 may become stronger. In view of this, it may be important to control the amount of time wherein the viscoelastic material layers 24, 26 may be in contact and the amount of pressure applied to the material layers 24, 26, in order to control the adhesion between the viscoelastic material layers 24, 26.

As shown in FIG. 5, air may then be removed from over the flexible membrane 36 and a vacuum may be formed over the flexible membrane 36. Optionally, air may be removed and a vacuum may be formed over the flexible membrane 36 substantially simultaneously to the removal of air and the formation of a vacuum between the flexible membrane 36 and the viscoelastic material layers 24, 26. As the vacuum is formed over the flexible membrane 36 the air within the defined space 32 may remain at a pressure near ambient pressure (i.e., local atmospheric pressure). As the viscoelastic material layers 24, 26 and covering woven fabric 34 and flexible membrane 36 are each flexible, when the surrounding pressure decreases due to the formation of a vacuum, the gas pressure within the defined space 32 may apply a force to the walls surrounding the defined space 32, as the gas pressure within the defined space 32 may be greater than the gas pressure over the second viscoelastic material layer 36. The gas pressure force may cause the second viscoelastic material layer 26 to expand and stretch, and the first and second viscoelastic material layers 24, 26 to peel apart. As shown, there may be no rigid caul plate positioned over the viscoelastic material layers 24, 26 (i.e., between the flexible membrane 36 and the viscoelastic material layers 24, 26), which may allow the second viscoelastic material layer 26 to expand and stretch due to the gas pressure within the defined space 32.

The rate of expansion of the defined space 32 may depend upon several factors, including: material properties of the viscoelastic material layers 24, 26, the adhesion strength between the viscoelastic material layers 24, 26, the depth of the defined space 32 beneath viscoelastic material layers 24, 26 (i.e., how thick each material layer 24, 26 is and how many material layers 24, 26 are positioned over the defined space 32) and the initial quantity and pressure of the gas within the defined space 32. For example, the higher the adhesion strength between the viscoelastic material layers 24, 26, the slower the rate of expansion of the defined space 32.

Additionally, the change in volume of the defined space 32 that may occur prior to reaching a state of equilibrium, a state wherein the volume of the defined space remains fixed, may also depend on such factors. For example, the higher adhesion strength between the viscoelastic material layers 24, 26, the smaller the change in volume of the defined space 32 that may occur before reaching a state of equilibrium. Furthermore, the greater the initial quantity and pressure of the gas within the defined space 32, the greater the change in volume of the defined space 32 that may occur before reaching a state of equilibrium.

As shown in FIG. 6, after a period of time, for example, about 22 minutes in some embodiments, the interface between the first and second viscoelastic material layers 24, 26 may separate until a discrete fluid path 42 may be formed between the first and second viscoelastic material layers 24, 26. Once the discrete fluid path 42 is formed, the air, or other gas, contained within the defined space 32 may escape through the discrete fluid path 42.

It is important that a sufficient quantity of gas is contained within the defined space 32 to facilitate enough expansion of the defined space 32, prior to reaching a state of equilibrium, to separate the viscoelastic material layers 24, 26 at least the distance D₁ (FIG. 4) to form the discrete fluid path 42 between the defined space 32 and the vacuum under the flexible membrane 36. Therefore, although the end goal is to remove gas, such as air, from between the viscoelastic material layers 24, 26, the configuration of the viscoelastic material layers 24, 26 relative to one another may result in at least a specific quantity of gas being initially contained within the defined space 32. Additionally, the more gas that is initially contained within the defined space 32, the greater the overlap may be between viscoelastic material layers 24, 26 and the greater the distance D₁ (FIG. 4) may be between the defined space 32 and the vacuum formed over the viscoelastic material layers 24, 26.

As the air escapes the defined space 32 the pressure may be relieved within the defined space 32 and the second viscoelastic material layer 26 may elastically deform to a relaxed state. However, although a vacuum is formed within the defined space 32, the defined space 32 may remain open, as the pressure within the defined space 32 may be substantially the same as the pressure over the second viscoelastic material layer 26 and the flexible membrane 36 and, so, there may not be any gas pressure force acting on the second viscoelastic material layer 26 to cause the second viscoelastic material layer 26 to be pressed down and close the defined space 32.

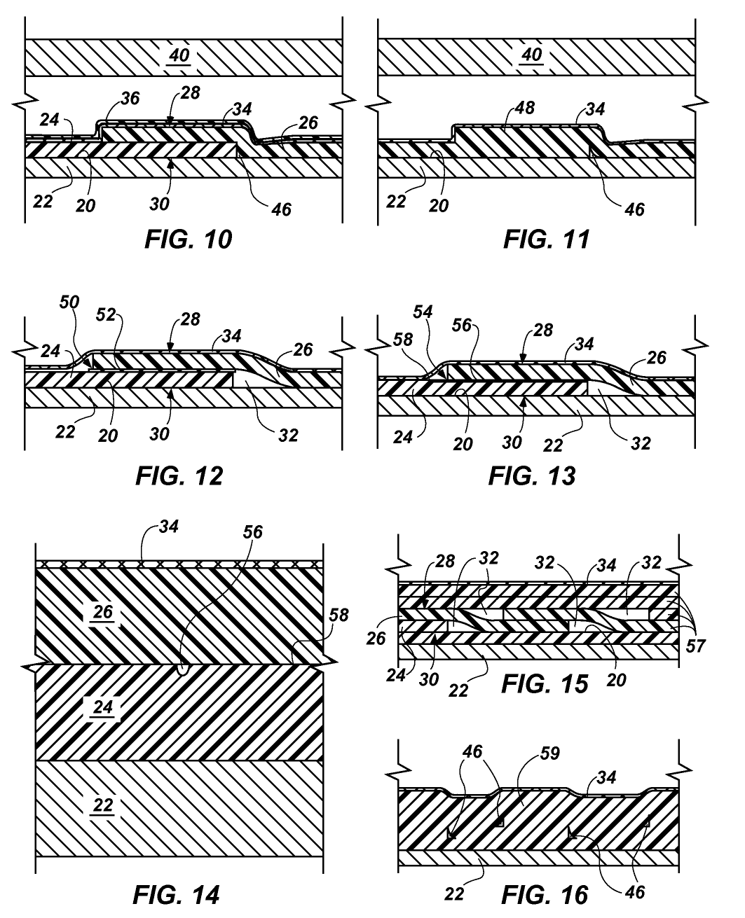

After the gas within the defined space 32 has been substantially removed and a vacuum has been formed in the defined space 32, gas may be injected over the flexible membrane 36 and an isostatic fluid pressure, such as ambient air pressure, may be applied, as shown in FIG. 7. For example, the autoclave 40 may be vented to atmospheric air. As isostatic air pressure is applied over the flexible membrane 36 the second viscoelastic material layer 26 may become pressed against the first viscoelastic material layer 24 and the surface 20 of the substrate 22 and the second viscoelastic material layer 26 may become deformed and the interfaces between the second viscoelastic material layer 26, first viscoelastic material layer 24 and surface 20 of the substrate 22 may be substantially free of voids. Optionally, one or more voids may remain, and each may exhibit a vacuum therein, as further described herein with reference to FIGS. 10 and 11.

Next, as shown in FIG. 8, the viscoelastic material layers 24, 26 may be cured, such as by a vulcanizing process. For example, heat may be applied to the viscoelastic material layers 24, 26 with a heat source, such as the autoclave 40. The viscoelastic material layers 24, 26 may become bonded during the curing process and may form a unitary cured material layer 44 (i.e., a unitary vulcanized elastomer structure). Additionally, the substrate 22 may become bonded to the unitary cured material layer 44.

Finally, the substrate 22 and the unitary cured material layer 44 thereon may then be removed from the autoclave 40 and the flexible membrane 36 and woven fabric 34 may be removed, as shown in FIG. 9.

In additional embodiments, as shown in FIG. 10, after at least a portion of the quantity of gas has been removed from the defined space 32 and a vacuum has been formed within the defined space 32, such as described with reference to FIG. 6, gas may be injected over the flexible membrane 36 and an isostatic fluid pressure may be applied to the flexible membrane 36, such as described with reference to FIG. 7. However, the viscoelastic material layers 24, 26 may have sufficient strength to resist deformation that may completely close the interfaces between the viscoelastic material layers 24, 26, and at least one void 46 may remain and the void 46 may exhibit at least a partial vacuum therein. For example, the void 46 may have a gas pressure less than about 1 psia. In another example, the void 46 may be substantially free of gases.

As shown in FIG. 11, the viscoelastic material layers 24, 26 may be cured and may form a unitary cured material layer, such as a unitary elastomer structure 48, which may have one or more voids 46 therein, each exhibiting at least a partial vacuum. For example, the viscoelastic material layers 24, 26 may be vulcanized in the autoclave 40 and may form a unitary elastomer structure 48 which may have one or more voids 46 therein, each defining a space having a gas pressure less than local atmospheric pressure. In some embodiments, a unitary elastomer structure 48 may have one or more voids 46 exhibiting a pressure less than about 1 psia.

In some embodiments, the substrate 22 may comprise a unitary, substantially rigid material; for example, the substrate 22 may be a unitary steel structure and the void 46 may be defined by the unitary elastomer structure 48 and the unitary steel structure. In additional embodiments, the substrate 22 may initially comprise a viscoelastic material layer, which may be cured with the viscoelastic material layers 24, 26 and may become united with the viscoelastic material layers 24, 26 to form the unitary elastomer structure 48. In such embodiments, the void 46 may be defined solely by the unitary elastomer structure 48.

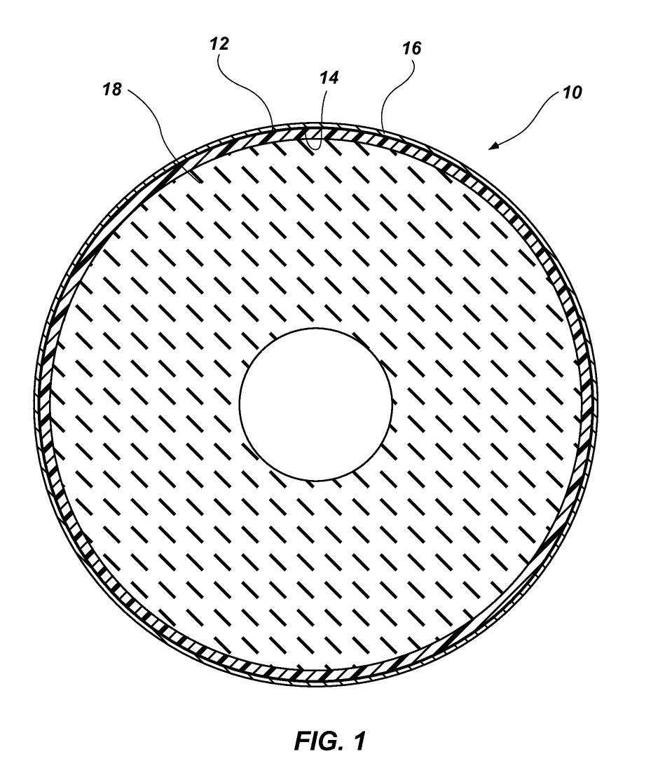

Unitary elastomer structures having cavities that are voids, which exhibit at least a partial vacuum, may be advantageous over unitary elastomer structures having cavities that contain a substantial amount of a fluid, such as a gas. For example, a unitary elastomer structure may form an insulation material layer 12 for a solid rocket motor 10, as described with reference to FIG. 1; wherein cavities containing gases therein may cause failure of the rocket motor 10 and cavities exhibiting vacuums therein may alleviate any tendency of failure of the rocket motor 10 in comparison to an insulation material layer 12 comprising gas-filled cavities.

For example, if a cavity in the insulation material layer 12 is positioned within or near a high stress region contains a significant amount of gas, the contained gas may cause additional localized stress near the cavity, such as due to the gas pressure acting within the cavity, which may initiate a fracture that may propagate through the insulation material layer 12. However, a void exhibiting a vaccum within or near a high stress region in the insulation material layer 12 may not cause such a failure, as the region of the insulation material layer 12 near the void may experience less localized stress, when compared to a cavity containing a significant amount of gas. Additionally, a cavity in the insulation material layer 12 that contains a significant amount of gas may off-gas, which may result in significant problems. For example, an insulation material layer 12 including trapped gas pockets relatively near to a propellant grain 18 may off-gas into the uncured propellant during casting operations, which may create voids at the interface between the insulation material layer 12 and the propellant grain 18 and within the propellant grain 18. Such voids between the insulation material layer 12 and the propellant grain 18 or within the propellant grain 18 may fracture during storage, vertical stack, or operation, which, in turn, may result in catastrophic failure of the rocket motor 10. However, a void exhibiting vacuum within the insulation material layer 12 may not off-gas.

In additional embodiments, as shown in FIG. 12, methods similar to those described with reference to FIGS. 2-9 may be implemented; additionally, a discrete fluid pathway 50 may be formed by the insertion of a gas permeable material 52 between the viscoelastic material layers 24, 26 to provide the discrete fluid pathway 50. In one embodiment, the gas permeable material 52 may be comprised of a fibrous material, such as a thread or piece of cloth, which may be positioned between the overlapping edge portions 28, 30 of the viscoelastic material layers 24, 26 and may provide the discrete fluid path 50 between a defined space 32 having a quantity of gas contained therein and a vacuum formed over the viscoelastic material layers 24, 26. For example, the gas permeable material 52 may be comprised of the same fiber that may be used as a reinforcing fiber for the viscoelastic material layers 24, 26, such as one of PBI fiber and asbestos fiber.

In another embodiment, the gas permeable material 52 may comprise a powdered material, such as powdered talc.

In yet additional embodiments, the gas permeable material 52 may comprise a liquid material. As a non-limiting example, the gas permeable material 52 may comprise a liquid polymer material that may be similar in composition to the viscoelastic material layers 24, 26. In view of this, the gas permeable material 52 may become integrally bonded with the viscoelastic material layers 24, 26 during a subsequent curing process.

Additionally, embodiments that utilize a gas permeable material 52 to provide a discrete fluid pathway 50 may include the gas permeable material 52 only at discrete regions between the viscoelastic material layers 24, 26, such as one or more elongated pathways, and not arranged between an entire interface between the viscoelastic material layers 24, 26. Leaving regions of the interface between the viscoelastic material layers 24, 26 without a material therebetween may allow the viscoelastic material layers 24, 26 to bond together, which may support the weight of the viscoelastic material layers 24, 26 and hold the viscoelastic material layers 24, 26 in position, even when suspended from a surface. Additionally, the bond between the viscoelastic material layers 24, 26 upon curing (i.e., vulcanizing) may be reliable when regions of the interface between the viscoelastic material layers 24, 26 are free of material therebetween.

In further embodiments, as shown in FIGS. 13 and 14, methods similar to those described with reference to FIGS. 2-9 may be implemented; additionally, a discrete fluid pathway 54 may be formed between viscoelastic material layers 24, 26 by forming a groove 56 within a surface 58 of one or more of the viscoelastic material layers 24, 26, the groove 56 extending along the interface between the viscoelastic material layers 24, 26. In view of this, the groove 56 may extend between the defined space 32 having a quantity of gas therein and a vacuum located over the viscoelastic material layers 24, 26. Optionally, the groove may be filled with viscoelastic material by the deformation of the viscoelastic material layers 24, 26 by an application of isostatic fluid pressure after gases have been substantially removed from the defined space and the groove in a manner similar to that described with reference to FIGS. 6 and 7.

Although embodiments of the invention have been described and illustrated with respect to FIGS. 2-13 as initially including two viscoelastic material layers 24, 26, to reduce the complexity of the figures and facilitate a clear understanding of the invention, embodiments also include structures and methods wherein three or more viscoelastic material layers are utilized. For example, an embodiment may include a substrate 22 comprising a rigid structure and a viscoelastic material layer and the first viscoelastic material layer 24 may be positioned on a surface 20 of the viscoelastic material layer of the substrate 22. The embodiment may also include a second viscoelastic material layer 26 having a portion 28 positioned over a portion 30 of the first viscoelastic material layer 24 forming a defined space 32 containing a quantity of gas, and a plurality of additional viscoelastic material layers 57 positioned over the first and second viscoelastic material layers 24, 26 and defining additional defined spaces 32 containing quantities of gas, such as shown in FIG. 15.

Furthermore, embodiments, such as formed by initial structures such as described with reference to FIG. 15, may include elastomer structures including a plurality of voids, each exhibiting at least a partial vacuum. For example, an embodiment may include a unitary elastomer structure 59 exhibiting a plurality of voids 46 each exhibiting a vacuum having a pressure less than about 1 psia, such as shown in FIG. 16, which may be formed from the assembly shown in FIG. 15 using methods similar to those described with reference to FIGS. 2-9.

Additionally, as will be understood by a person of ordinary skill in the art, a discrete fluid pathway to facilitate the removal of gases from a defined space under a viscoelastic material layer may be formed by a combination of methods and structures such as described herein.

### EXAMPLE

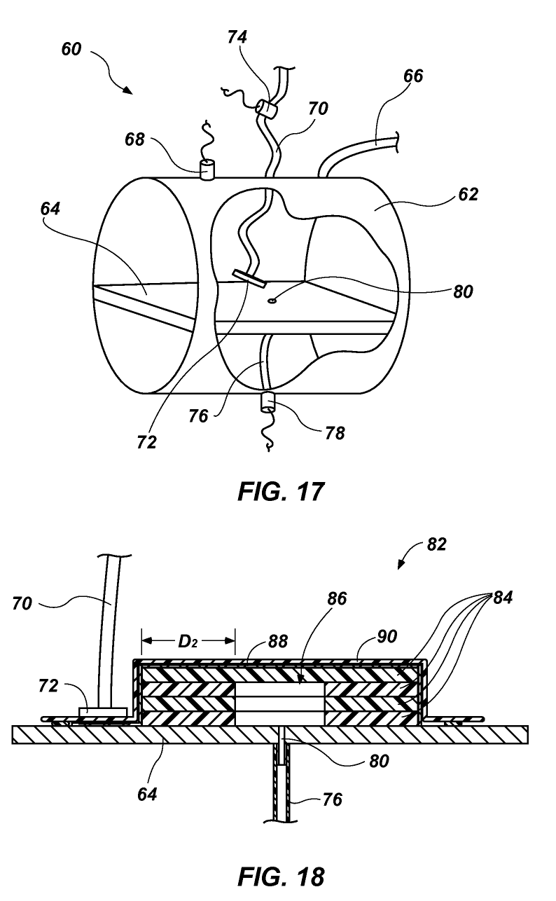

A testing apparatus 60 was assembled as shown in FIG. 17, including a vacuum chamber 62 sized to hold a specimen sheet 64 therein. A first vacuum source (not shown) was attached to the vacuum chamber 62 with a tube 66, and a pressure transducer 68 was installed in a wall of the vacuum chamber 62 to measure the air pressure within the vacuum chamber 62. A second vacuum source (not shown) was attached to a tube 70 that was routed through the wall of the vacuum chamber 62 and included a vacuum bag footing 72 configured for attachment to a vacuum bag and a pressure transducer 74 to measure the pressure within the tube 70. Another tube 76 was routed through the wall of the vacuum chamber 62, a first end of the tube was attached to a pressure transducer 78 and a second end was configured to attach to an aperture 80 formed through the specimen sheet 64, such that the transducer 78 could be utilized to measure the pressure over the aperture 80 of the specimen sheet 64.

As shown in FIG. 18, a test specimen 82 was assembled including a plurality of less than fully cured PBI-NBR sheets 84 assembled together onto the specimen sheet 64 and including a defined space 86 of about 21.6 cubic inches enclosing a quantity of air at local atmospheric pressure (about 12.6 psia) and positioned over the aperture 80 in the specimen sheet 64, so that the transducer 78 attached thereto could be utilized to monitor the air pressure within the defined space 86. The shortest distance D₂ between the defined space 86 in the PBI-NBR sheets 84 and the space outside of the PBI-NBR sheets 84 was about six (6) inches. A woven polyester cloth 88 was positioned above the PBI-NBR sheets 84 and a flexible membrane 90 (nylon vacuum bag) was positioned over the woven polyester cloth 88, sealed to the specimen plate 64 and attached to the vacuum bag footing 72 of the second vacuum source. The assembled test specimen 82 was then inserted into the vacuum chamber 62 of the testing apparatus 60 and a vacuum was applied by the first and second vacuum sources.

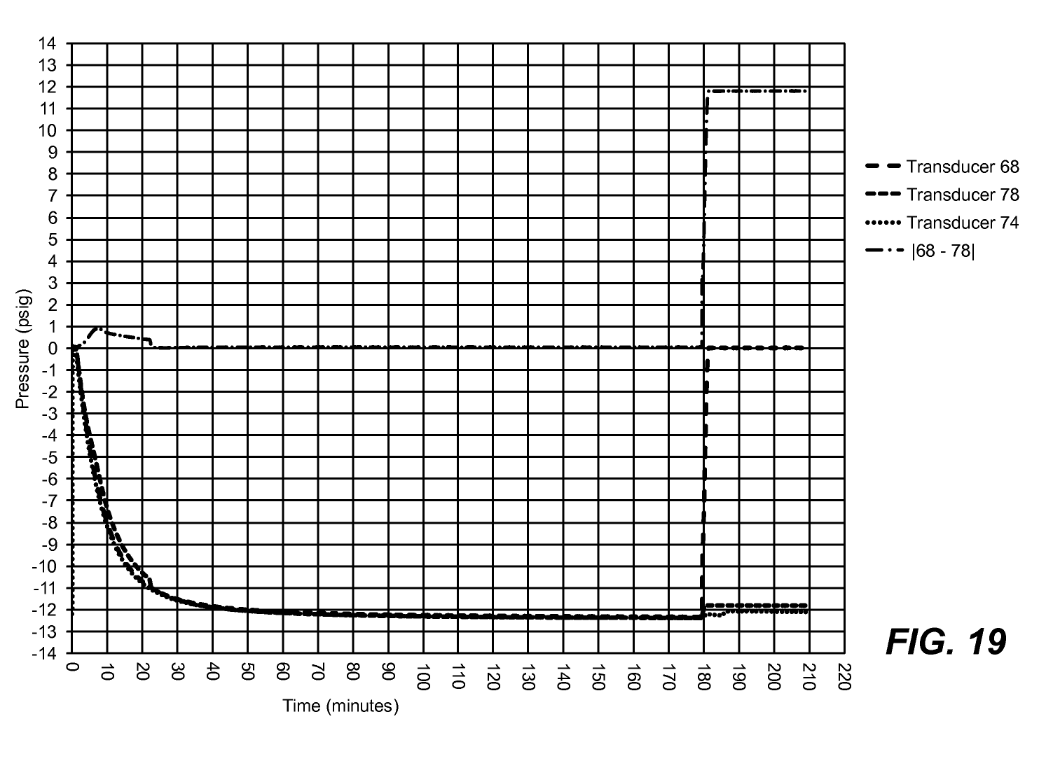

As shown in the graph of FIG. 19, the recorded data included the pressure within the vacuum chamber, taken by the transducer 68, the pressure within the defined space, taken by the transducer 78, and the pressure between the flexible membrane 90 and the outside of the PBI-NBR sheets 84, taken by the transducer 74, each recorded as psig. Additionally, the graph includes the calculated absolute value difference in pressure between the defined space 86 in the PBI-NBR sheets 84 and the pressure within the pressure chamber 62 (i.e., the absolute value of the pressure observed by the transducer 68 subtracted from the pressure observed by the transducer 78).

As air was withdrawn from each of the vacuum chamber 62 and the space beneath the flexible membrane 90, the air pressure of each space decreased uniformly. However, for about the first 22 minutes the air pressure within the defined space decreased more slowly. This is because the air pressure within the defined space 86 was reduced by the expansion of the defined space 86, rather than the removal of air. It appears that as the defined space 86 expanded, the PBI-NBR sheets 84 applied a force that acted against the force of the air pressure in the defined space 86 and caused the pressure in the defined space 86 to be higher than the surrounding pressure. This difference between the pressure in the defined space 86 and the surrounding pressure may be recognized by examining the calculated difference between these pressures, shown on the graph. The defined space 86 expanded until a discrete path was formed at about 22 minutes, at which point the quantity of air within the defined space 86 was withdrawn at a relatively quick rate through the discrete path and thereafter the air pressure within the defined space 86 closely matched the surrounding air pressure. After about 180 minutes the vacuum chamber 62 and the flexible membrane 90 were vented to the atmosphere. Data collected from the test showed about a 98 percent reduction of gas within the defined space 86, about a 76 percent reduction in volume of the defined space 86, and about a 94 percent reduction in the pressure within the defined space 86.

Although this invention has been described with reference to particular embodiments, the invention is not limited to these described embodiments. Rather, the invention is limited only by the appended claims, which include within their scope all equivalent devices, systems and methods.

1. A method of forming a structure from layered viscoelastic material, the method comprising:
covering at least a portion of a first viscoelastic material layer disposed on a substrate with a portion of at least a second viscoelastic material layer to form a defined space containing a quantity of gas between a portion of the substrate, a portion of the first viscoelastic material layer and a portion of the at least a second viscoelastic material layer;
forming at least one discrete fluid path between the defined space containing the quantity of gas and a vacuum; and
removing at least a portion of the quantity of gas from the defined space through the at least one discrete fluid path.

2. The method of claim 1, further comprising:
covering the first viscoelastic material layer and the at least a second viscoelastic material layer with a flexible membrane; and
forming the vacuum between the flexible membrane and the first viscoelastic material layer and the at least a second viscoelastic material layer.

3. The method of claim 2, further comprising positioning a woven fabric between the flexible membrane and the first viscoelastic material layer and the at least a second viscoelastic material layer.

4. The method of claim 2, further comprising:
positioning the substrate, the first viscoelastic material layer and the at least a second viscoelastic material layer and the flexible membrane within an autoclave; and
forming a vacuum within the autoclave outside of the flexible membrane.

5. The method of claim 2, wherein forming at least one discrete fluid path between the defined space containing the quantity of gas and the vacuum comprises expanding the defined space containing the quantity of gas and separating the first viscoelastic material layer and the at least a second material layer until an opening is created between the defined space containing the quantity of gas and the vacuum.

6. The method of claim 5, further comprising containing a sufficient quantity of gas within a defined space with the at least a second viscoelastic material layer to separate the first viscoelastic material layer and the at least a second viscoelastic material layer to form the opening by a gas pressure provided by the contained quantity of gas.

7. The method of claim 5, further comprising positioning an edge of the at least a second viscoelastic material layer at a location relative to the defined space containing the quantity of gas that allows a gas pressure provided by the contained quantity of gas to separate the first viscoelastic material layer and the at least a second viscoelastic material layer to form the at least one discrete fluid path.

8. The method of claim 1, wherein forming at least one discrete fluid path between the defined space containing the quantity of gas and the vacuum comprises cutting at least one groove into a surface of at least one of the first and the at least a second viscoelastic material layers, the at least one groove extending from the defined space containing the quantity of gas to the vacuum.

9. The method of claim 1, wherein forming at least one discrete fluid path between the defined space containing the quantity of gas and the vacuum comprises positioning a gas permeable material between the first and the at least a second viscoelastic material layers to provide a gas permeable path extending from the defined space containing the quantity of gas to the vacuum.

10. The method of claim 9, wherein positioning a gas permeable material between the first viscoelastic material layer and the at least a second viscoelastic material layer comprises positioning a fibrous material between the first viscoelastic material layer and the at least a second viscoelastic material layer.

11. The method of claim 9, wherein positioning a gas permeable material between the first viscoelastic material layer and the at least a second viscoelastic material layer comprises positioning a powdered material between the first viscoelastic material layer and the at least a second viscoelastic material layer.

12. The method of claim 9, wherein positioning a gas permeable material between the first viscoelastic material layer and the at least a second viscoelastic material layer comprises positioning a liquid material between the first viscoelastic material layer and the at least a second viscoelastic material layer.

13. The method of claim 1, wherein covering at least a portion of a first viscoelastic material layer with a portion of at least a second viscoelastic material layer comprises covering at least a portion of a first less than fully cured polybenzimidazole fiber reinforced nitrile butadiene rubber sheet with a portion of at least a second less than fully cured polybenzimidazole fiber reinforced nitrile butadiene rubber sheet.

14. The method of claim 1, wherein:
the quantity of gas contained within the defined space comprises a quantity of air contained within the defined space; and
forming at least one discrete fluid path between the defined space containing the quantity of gas and the vacuum comprises forming at least one discrete fluid path between the defined space containing the quantity of air and the vacuum; and
removing at least a portion of the quantity of gas from the defined space through the at least one discrete fluid path comprises removing at least a portion of the quantity of air from the defined space through the at least one discrete fluid path.

15. The method of claim 2, further comprising applying an isostatic pressure to the flexible membrane, the first viscoelastic material layer and the at least a second viscoelastic material layer.

16. The method of claim 15, wherein applying an isostatic pressure comprises applying ambient atmospheric pressure to the flexible membrane, the first viscoelastic material layer and the at least a second viscoelastic material layer.

17. The method of claim 1, wherein covering at least a portion of a first viscoelastic material layer disposed on a substrate with a portion of at least a second viscoelastic material layer comprises covering at least a portion of a first viscoelastic material layer, the first viscoelastic material layer disposed on at least a third viscoelastic material layer of a substrate comprising the third viscoelastic material layer, with a portion of at least a second viscoelastic material layer.

18. A unitary elastomer structure, comprising: at least one void defined therein, the at least one void exhibiting at least a partial vacuum.

19. The unitary elastomer structure of claim 18, wherein the unitary elastomer structure is positioned between a heat source and a heat sensitive structure to provide thermal insulation therebetween.

20. The unitary elastomer structure of claim 19, wherein the unitary elastomer structure is adhered to a casing of a solid rocket motor between the casing and a solid propellant grain.

21. The unitary elastomer structure of claim 20, wherein the unitary elastomer structure comprises polybenzimidazole fiber reinforced nitrile butadiene rubber.

22. The unitary elastomer structure of claim 20, wherein the unitary elastomer structure comprises asbestos fiber reinforced nitrile butadiene rubber.

23. The unitary elastomer structure of claim 18, wherein the void exhibits a gas pressure of less than about 1 psia.

24. A solid rocket motor comprising: an insulation layer comprised of a unitary elastomer structure having at least one void defined therein, the at least one void exhibiting at least a partial vacuum.

25. The solid rocket motor of claim 24, wherein the insulation layer is adhered to a casing and positioned between the casing and a solid propellant grain.

26. The solid rocket motor of claim 25, wherein the unitary elastomer structure comprises polybenzimidazole fiber reinforced nitrile butadiene rubber.

27. The solid rocket motor of claim 25, wherein the unitary elastomer structure comprises asbestos fiber reinforced nitrile butadiene rubber.

28. The solid rocket motor of claim 24, wherein the at least one void exhibits a gas pressure of less than about 1 psia.
